(19) United States
(12) Patent Application Publication
(10) Pub. No.: US 2003/0107357 A1
(43) Pub. Date: Jun. 12, 2003

(54) Vehicle electric power unit

(75) Inventors: Tsuyoshi Uchikura, Shizuoka-ken (JP); Hiroo Yabe, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/310,845

(22) Filed: Dec. 6, 2002

(30) Foreign Application Priority Data
Dec. 7, 2001 (JP) P 2001-374467

(51) Int. Cl. G05F 1/44

(52) U.S. Cl. 323/282

(57) ABSTRACT

In a vehicle electric power unit, DC voltage supplied from a vehicle electric power source is PWM driven to generate a PWM signal, the PWM signal is supplied to a lamps L1 and L2 mounted in the vehicle to light the lamps. The first three pulse signals of the PWM signal at the time of throwing of electric power source voltage is set to a duty ratio which is two times of a pulse signal at the time of normal case, and the first pulse signal is provided with slope whose voltage value gradually increases.

### BACKGROUND OF THE INVENTION

1. Field of the Invention

The present invention relates to a vehicle electric power unit used to light various lamps mounted in a vehicle.

2. Description of Related Art

As a conventional vehicle electric power unit, one described in Japanese Patent Application Laid-Open No. H1-185197 is known. In this art, it is described that voltage suitable for a load is supplied by appropriately changing (i.e., using PWM driving) a duty ratio of a voltage signal supplied from an electric power source.

Here, if voltage is supplied to light a light bulb when a filament of the light bulb is cold, since a resistance value of the filament is extremely small, current of about 5 to 12 times greater than steady-state current initially flows. Thereafter, the resistance value of filament increased by electric power consumption, and current coinciding with a standard value flows.

According to a control method described above, when voltage of an electric power source is increased to high voltage, since the resistance value of the filament is the same, the inrush current also increased substantially in proportion to a multiple of voltage. Therefore, a trouble that the filament is blew out by excessive heat generated by the inrush current occurs in some cases.

Further, even if the blowout of the filament is not generated, a lifetime of the filament is reduced by damage caused by high inrush current. There is a problem that if the inrush current becomes greater, a factor for generating noise is increased.

### SUMMARY OF THE INVENTION

The present invention has been accomplished to solve the above conventional problem, and it is an object of the invention to provide a vehicle electric power unit capable of limiting the inrush current and obtaining sufficient speed of response to light a low voltage light bulb with a high voltage electric power source using the PWM driving.

To achieve the above object, a first aspect of the present application provides a vehicle electric power unit in which DC voltage supplied from a vehicle electric power source is PWM driven to generate a PWM signal, the PWM signal is supplied to a lamp load mounted in the vehicle to light the lamp load, wherein the first predetermined number of pulse signals of the PWM signal at the time of throwing of electric power source voltage is set to a duty ratio greater than a pulse signal at the time of normal case, and the first pulse signal is provided with slope whose voltage value gradually increases.

A second aspect of the application provides a vehicle electric power unit in which DC voltage supplied from a vehicle electric power source is PWM driven to generate a PWM signal, the PWM signal is supplied to a lamp load mounted in the vehicle to light the lamp load, wherein the vehicle electric power unit comprises an electronic switch disposed between the vehicle electric power source and the lamp load, PWM control means for generating a PWM signal having a desired duty ratio by the vehicle electric power source, and gate voltage control means which controls such that the first predetermined number of pulse signals of the PWM signal at the time of throwing of voltage into the lamp load is set to a duty ratio greater than a pulse signal at the time of normal case, and a waveform of the first pulse signal is provided with slope whose voltage value gradually increases.

According to the vehicle electric power unit of the present invention, only the first predetermined times (e.g., three times) of the PWM signal to be supplied to the gate of the electronic switch (MOS-FET 4) is set to a duty ratio greater (e.g., two times greater) than a pulse signal at the time of normal case, and the first pulse signal is provided with slope whose voltage value gradually increases. Therefore,it is possible to prevent excessive current from flowing through the lamp load at the time of throwing of electric power source to the lamp load. Further, the lifetime of the lamp load can be elongated.

Further, since the current value is instantaneously stabilized, time required until the lamp load is lit can be shortened.

### BRIEF DESCRIPTION OF THE DRAWINGS

FIG. 1 is a block diagram showing a structure of a vehicle electric power unit according to an embodiment of the present invention;

FIGS. 2 show characteristics of variation in gate voltage of an MOS-FET and a load current (current flowing through a lamp) when a technique of the embodiment is not employed;

FIG. 3 is a circuit diagram showing a concrete structure of a gate voltage control circuit;

FIG. 4 shows characteristics of variation of signals of various portions of the circuit diagram shown in FIG. 3;

FIGS. 5 show characteristics of variation in gate voltage of the MOS-FET and the load current (current flowing through a lamp) when the technique of the embodiment is employed; and

FIG. 6 is an explanatory diagram showing a range of a rate of change of slope of a voltage signal.

### DESCRIPTION OF THE PREFERRED EMBODIMENT

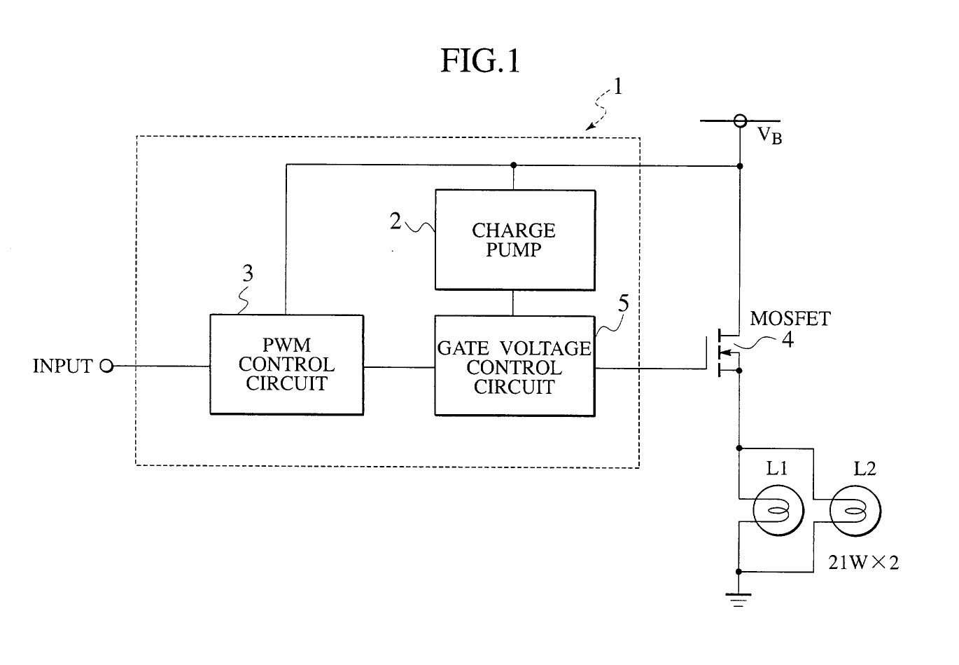

An embodiment of the present invention will be explained below based on the drawings. FIG. 1 is a block diagram showing a structure of a vehicle electric power unit according to an embodiment of the present invention. As shown in FIG. 1, a vehicle electric power unit 1 controls ON and OFF of an MOS-FET 4 (electronic switch) disposed between two lamps L1 and L2 connected to a battery VB in parallel. The vehicle electric power unit 1 comprises a charge pump 2 which temporarily accumulates voltage supplied from the battery mounted in a vehicle, a PWM control circuit 3 which PWM-drives a battery voltage based on a PWM control signal, and outputs a voltage signal having a predetermined duty ratio, and a gate voltage control circuit 5 which provides a gate of an MOS-FET 4 with driving voltage based on a voltage signal output from the PWM control circuit 3 and a voltage signal sent from the charge pump.

The gate voltage control circuit 5 operates such that the rising of gate voltage is provided with slope and the gate voltage is gradually increased.

The charge pump 2 generates voltage which becomes electric power source voltage +10 volts (this is called voltage VP), and generally drives an N-ch power-MOS-FET in a saturation region.

The PWM control circuit 3 controls a duty ratio such that an electric power consumption of a load becomes equal to that when a 12-volt electric power source is used while monitoring the electric power source voltage, and output a PWM waveform.

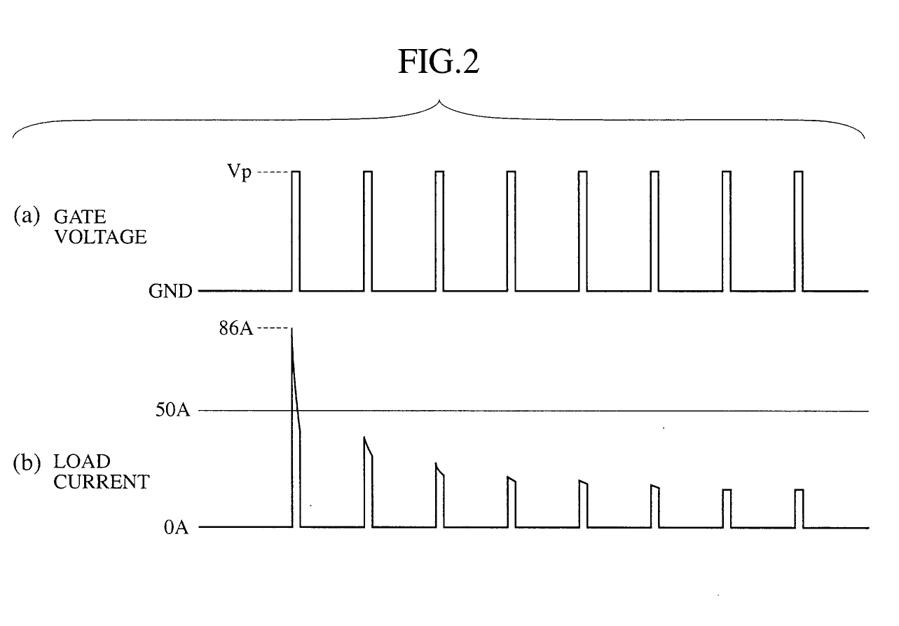

FIGS. 2 are explanatory views showing inrush current characteristics when PWM control is carried out in a state in which battery voltage is 36.7 volts. As shown in FIG. 2(a), voltage VP (battery voltage +10 volts) is applied to a gate of the MOS-FET 4 at a duty ratio in which electric power consumption is controlled to a desired electric power consumption. At that time, as shown in FIG. 2(b), the maximum inrush current reaches 86 amperes. To solve this problem, gate voltage of the MOS-FET 4 is reduced. With this, source voltage can be reduced. As a result, the inrush current can be suppressed.

According to this control, however, two problems come up. One of the problems is that the electric power consumption of the MOS-FET 4 is increased. The other problem is that since the electric power consumption of the lamps L1 and L2 is increased, time required until the lamps are lit is increased.

The reason why the electric power consumption of the MOS-FET 4 is increased is that if the gate voltage is reduced, the MOS-FET 4 is operated in a liner region and thus, voltage between source and drain is increased. The voltage between source and drain is normally several tens to several hundreds mV, but this voltage becomes about 20 to 30 volts and with this, the electric power consumption becomes 100 to 1,000 times greater.

Electricity consumed by the lamps L1 and L2 is reduced by electricity consumed by the MOS-FET 4, time required for increasing the resistance value of the filament is increased, which is a factor for increasing the lighting time. To solve these problems, the gate voltage is provided with slope, voltage should be suppressed at the initial stage of lighting, and the voltage should be increased gradually. If the voltage is increased with increase of the resistance value of the filament, a load current is not increased.

Further, if the duty ratio of the initial stage of lighting is appropriately increased, it is possible to shorten the lighting time.

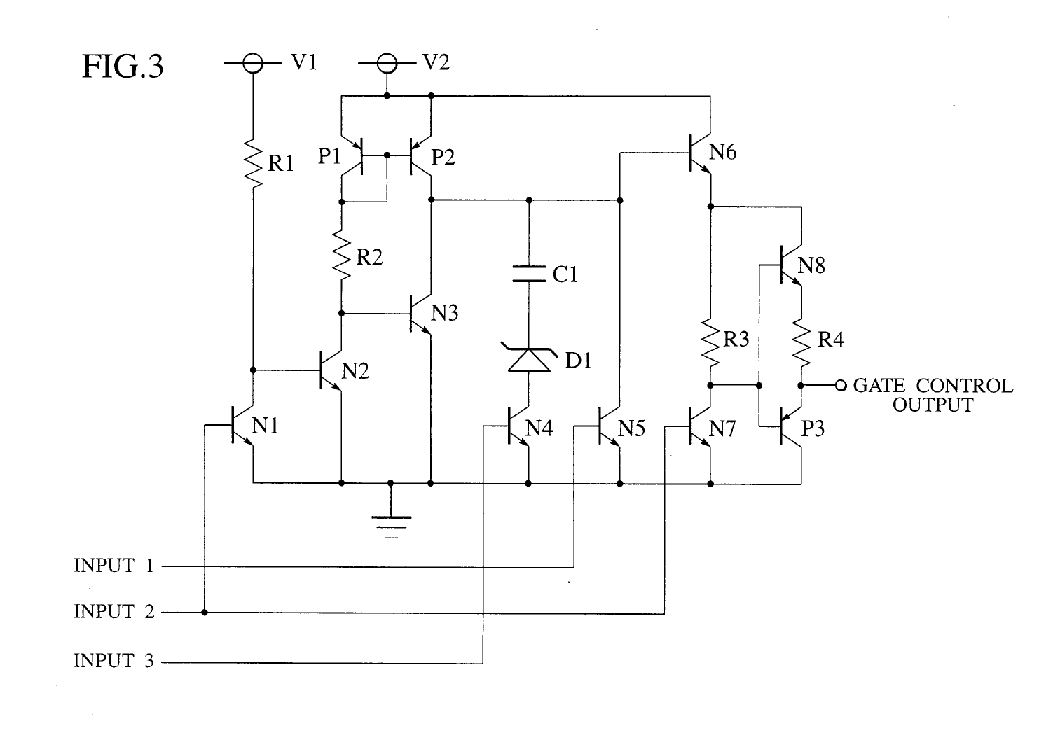

FIG. 3 is a circuit diagram showing a concrete structure of the gate voltage control circuit 5. Although FIG. 3 show bipolar transistors (N1 to N8, P1 to P3) for simplification, other elements (MOS-FET or the like) can also be used.

As shown in FIG. 3, this control circuit comprises transistors N1 to N8 and P1 to P3, a capacitor C1, a Zener diode D1 and resistances R1 to R4. In FIG. 3, voltage V1 is usually VCC power source (5 volts), and V2 is usually VP electric power source (VB+10 volts).

An input 1 is a lighting signal of the lamps L1 and L2. When this signal is H level, the gate control output is OFF. When the input 1 is L level, the gate control output is active.

An input 2 is a PWM control signal. This signal is converted into a signal of 0 to VP by an output stage formed by the transistors N6 to N8, P3, R3 and R4. When this signal is H level, a capacitor of the capacitor C1 is charged, and when the signal is L level, the capacitor C1 is discharged.

An input 3 is a signal for forming the slope of the gate voltage. When a signal of the input 3 is H, voltage downstream of the capacitor C1 is clamped by the Zener diode D1. Voltage upstream of the capacitor C1 is increased as the charging of the capacitor C1 is proceeded.

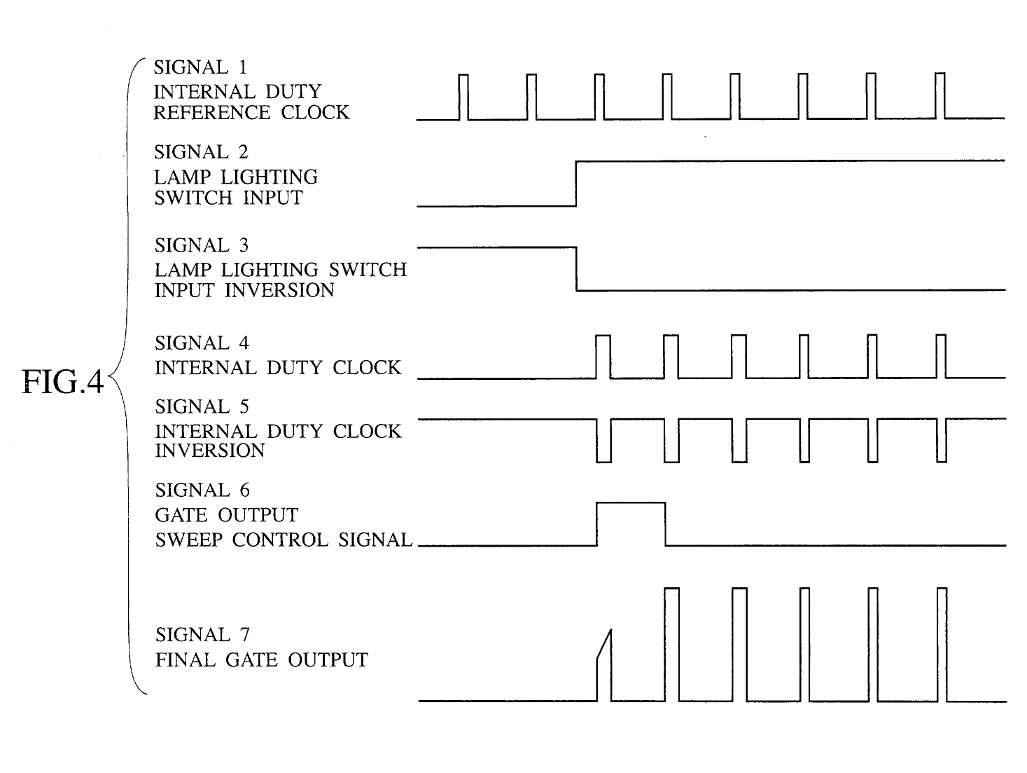

FIG. 4 shows waveforms of signals at various points of the circuit shown in FIG. 3. A signal 1 shown in FIG. 4 is a signal generated in the gate voltage control circuit 5. The duty ratio is adjusted while monitoring a magnitude of the battery voltage (VB shown in the drawing). A signal 2 is a lamp lighting switch input from outside, and an inverted signal (signal 3 in FIG. 4) is input to the input 1. A signal 4 is a PWM clock signal generated for a gate output control signal, and an inverted signal (signal 5 in FIG. 4) is input to the input 2 shown in FIG. 3. The duty ratio of each of three pulse signals of initial stage of lighting is controlled to two times of normal value. A signal 6 is a sweep control signal of the gate output, and this signal corresponds to the input 3 shown in FIG. 3. A signal 7 is a gate signal (signal sent to the gate of the MOS-FET 4).

From FIG. 4, it is understood that only first three pulses of the gate control output (signal 7) has great duty ratio, and a waveform of the first one pulse has slope.

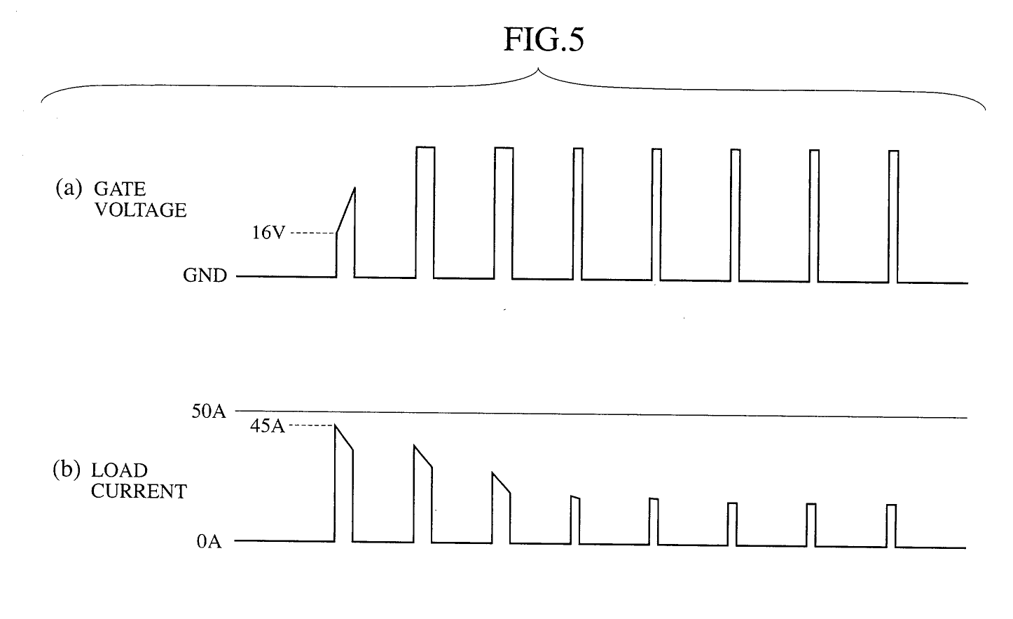

FIG. 5(a) is an explanatory view showing characteristics of gate voltage when the electric power unit of the embodiment is used, and FIG. 5(b) is an explanatory view showing characteristics of the load current. In this embodiment, the initial voltage of the gate is suppressed to 16 volts to lower the inrush current. The gate voltage is provided with slope to meet with increase in resistance of the filaments of the lamps L1 and L2. Further, the duty ratios of the initial three pulses are set to two times of a normal duty ratio (duty ratio which is optimal with respect to voltage).

As a result, the maximum inrush current of current is suppressed to 45 volts, and time until the current is stabilized is also shortened. This means that the lighting time (time required until the lamps L1 and L2 are lit) is shortened. Here, the initial voltage is preferably 6 to 20 volts (a range of general 12 volt-based battery operated electric power source voltage).

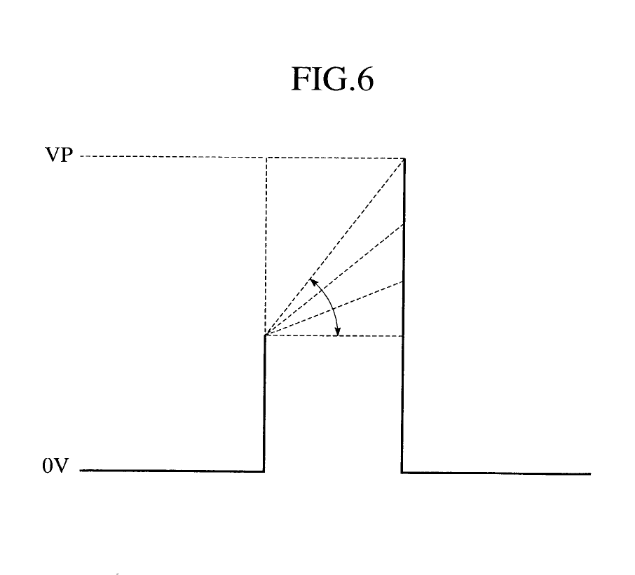

As shown with an arrow in FIG. 6, it is preferable that the maximum voltage of slope is in a range of (initial voltage) to (VP voltage). The duty ratio is preferably one to two times because of lifetime of each of the lamps L1 and L2 (when PWM frequency is 100 Hz). The PWM frequency is preferably 100 Hz or higher.

This is because that if frequency is low, since period is reciprocal of the frequency, the lighting time per light bulb one pulse becomes long, which becomes a factor for shortening the lifetime of the light bulb.

The number of pulses which change the duty ratio is adjusted based on period of PWM, and the number is set to number which remains within a desired lighting time. According to the embodiment, it is possible to reduce a load applied to the MOS-FET 4, and to shorten the lighting time while suppressing the inrush current. With this, it is possible to stabilize the lighting and to increase the lifetime of the lamp when a 12 volt lamp is PWM operated with high voltage electric power source.

What is claimed is:

1. A vehicle electric power unit in which DC voltage supplied from a vehicle electric power source is PWM driven to generate a PWM signal, the PWM signal is supplied to a lamp load mounted in the vehicle to light the lamp load, wherein
the first predetermined number of pulse signals of the PWM signal at the time of throwing of electric power source voltage is set to a duty ratio greater than a pulse signal at the time of normal case, and the first pulse signal is provided with slope whose voltage value gradually increases.

2. A vehicle electric power unit in which DC voltage supplied from a vehicle electric power source is PWM driven to generate a PWM signal, the PWM signal is supplied to a lamp load mounted in the vehicle to light the lamp load, the vehicle electric power unit comprising:
an electronic switch disposed between the vehicle electric power source and the lamp load;
PWM control means for generating a PWM signal having a desired duty ratio by the vehicle electric power source; and
gate voltage control means which controls such that the first predetermined number of pulse signals of the PWM signal at the time of throwing of voltage into the lamp load is set to a duty ratio greater than a pulse signal at the time of normal case, and a waveform of the first pulse signal is provided with slope whose voltage value gradually increases.

3. A vehicle electric power unit in which DC voltage supplied from a vehicle electric power source is PWM driven to generate a PWM signal, the PWM signal is supplied to a lamp load mounted in the vehicle to light the lamp load, the vehicle electric power unit comprising:
an electronic switch disposed between the vehicle electric power source and the lamp load;
PWM control means for generating a PWM signal having a desired duty ratio by the vehicle electric power source; and
gate voltage control circuit which controls such that the first predetermined number of pulse signals of the PWM signal at the time of throwing of voltage into the lamp load is set to a duty ratio greater than a pulse signal at the time of normal case, and a waveform of the first pulse signal is provided with slope whose voltage value gradually increases.

4. A vehicle electric power unit according to claim 3, wherein the gate voltage control circuit inputs a lighting signal from the electronic switch, a PWM signal from the PWM control circuit, and a sweep control signal of gate output, and the gate voltage control circuit outputs a gate control signal whose first pulse signal have a slope-like waveform.
